(19) United States
(12) Patent Application Publication
(10) Pub. No.: US 2006/0198431 A1
(43) Pub. Date: Sep. 7, 2006

(54) Activity monitor for multiple RF channels

(76) Inventors: John F. Turpin, Tigard, OR (US); Julian B. Sessions, Aloha, OR (US)

Correspondence Address: TEKTRONIX, INC., P.O. BOX 500, MS 50-LAW, BEAVERTON, OR, 97077, US

(21) Appl. No.: 11/071,704

(22) Filed: Mar. 2, 2005

(51) Int. Cl. H04B 17/00

(52) U.S. Cl. 375/224

(57) ABSTRACT

An activity monitor for a multiple channel RF signal acquires time domain data from the RF signal over a wide bandwidth that includes multiple channels. The acquired data is separated by individual channel filters to provide channel data for each channel. The channel data is measured to produce measurement results for each channel, and selected ones of the measurement results are combined for display as a simultaneous display. A selected portion of the acquired data is converted to the frequency domain to provide a spectral display as part of the simultaneous display.

### BACKGROUND OF THE INVENTION

The present invention relates to the measurement of characteristics of radio frequency (RF) signals, and more particularly to an activity monitor for displaying simultaneously the measurements of the characteristics of signals that are configured as multiple frequency channels.

In some mobile telephony technologies, such as TD-SCDMA (Time Domain Synchronous Code Division Multiple Access—uses a single frequency band for both uplink and downlink) and GSM (Global System for Mobile Communications—uses separate frequency bands for uplink and downlink), it is necessary to identify a point in time when certain landmark events occur. Some of these events are call setup, call teardown and handover. When these events occur, there is a recognizable change in the characteristics of the signal in each of the RF channels involved in the event, such as power-versus-time profiles. Since multiple RF carrier frequencies are involved in the completion of some of the events, it is desirable to monitor all frequency channels over the same time interval. However currently a swept frequency spectrum analyzer is tuned with zero span to a single frequency channel and so can only look at one of the uplink or downlink channels at a time (GSM) or only time slots in one frequency band (TD-SCDMA). This results in missing events that occur in another frequency band or while the swept frequency is re-traced, or in missing time slots and possibly events within the frequency band as the swept frequency is re-traced. Even with a realtime spectrum analyzer tuned to a single frequency channel, events that effect more than one frequency channel, such as handovers switching between frequency bands or simultaneous events in both an uplink and downlink frequency band, are not readily apparent.

What is desired is a method of simultaneously displaying the characteristics of an RF signal having multiple frequency bands and associated measurements on a single display in a time synchronous fashion.

### BRIEF SUMMARY OF THE INVENTION

Accordingly the present invention provides an activity monitor for multiple RF channels that provides a simultaneous display of the characteristics of several adjacent RF channels with corresponding measurements. A time domain acquisition of an RF input signal over a frequency bandwidth sufficient to cover the multiple channels of the particular communication system results in acquired data that is processed by each of a plurality of channel filters, each channel filter being centered on the frequency of a particular one of the channels. The separated data for each channel from the channel filters are then processed by an appropriate measurement algorithm to provide measurement results for each of the channels. The measurement results together with a frequency domain version of the acquired data are combined in a display processor to produce a simultaneous display having a spectrum view of a plurality of the channels and measurement views for each of the channels.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIG. 1 is a block diagram view of a system for providing an activity monitor for multiple RF channels of a communication signal according to the present invention.

FIG. 2 is a plan view of an illustrative display for the activity monitor according to the present invention.

FIG. 3 is a process block diagram view showing the steps for providing the activity monitor according to the present invention.

### DETAILED DESCRIPTION OF THE INVENTION

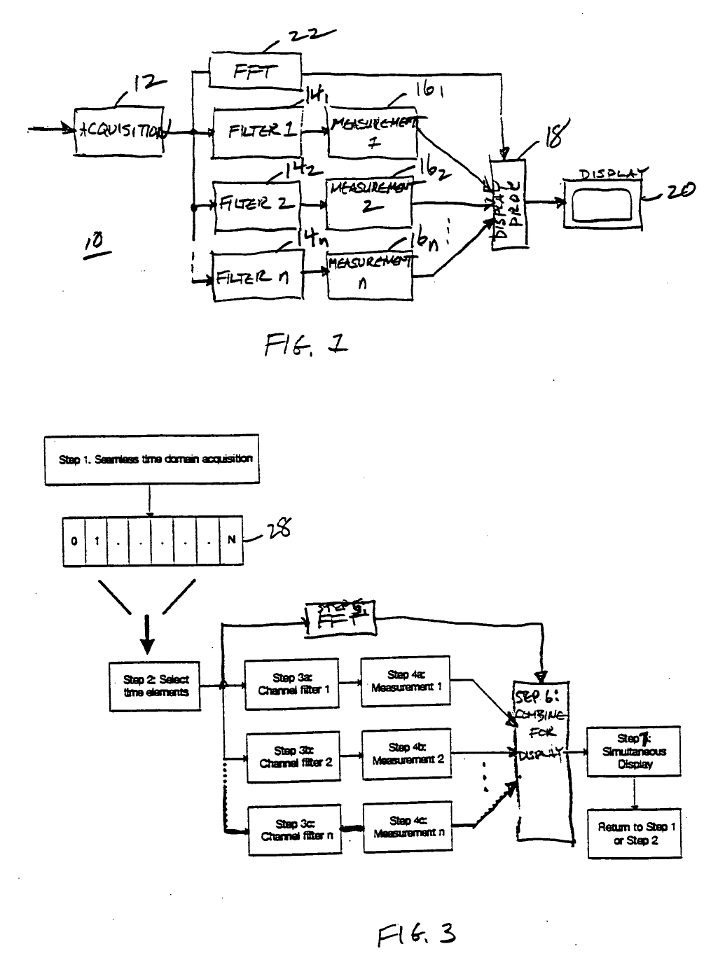

Referring now to FIG. 1 a system 10 is shown that has an acquisition module 12 capable of acquiring a wideband RF signal having several frequency channels simultaneously. In a realtime spectrum analyzer the entire communication frequency band may be acquired as time domain data. The channels or separate frequency bands within the entire communication frequency band are separated by respective channel filters 14, and the resulting data for each channel are then processed by a corresponding measurement subsystem 16. The measurement subsystems 16 may be the same for each channel, or a different measurement may be performed on each channel. The measurement results from the measurement subsystems 16 are combined by a display processor 18 and presented as a simultaneous display 20. The depth of the acquisition, or the amount of data acquired for each measurement cycle, is determined by the amount of data necessary to make a desired measurement. When the particular measurements are different for different channels, then the measurement that requires the most data determines the amount of the acquisition. The entire processing may be done by software using an appropriate processor having as inputs the acquired data and providing the combined raster scan display as an output for the simultaneous display 20.

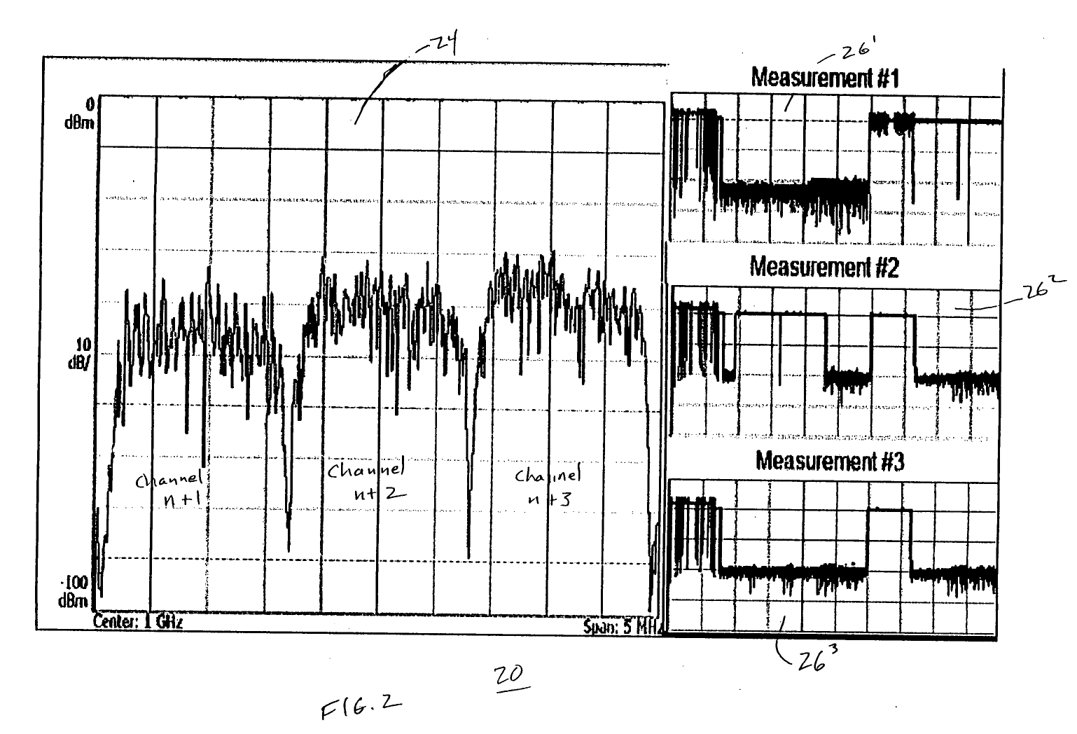

An example of a simultaneous display is shown in FIG. 2. In this display there is a spectrum view 24 of a selected bandwidth within the communication bandwidth, in this example showing three frequency bands or channels. Also shown to the right are time synchronized measurement results 26 for the three frequency bands in the form of power versus time profiles. The signal shown is part of a TD-SCDMA system. The spectrum view 24 is formed by processing the data from the acquisition module 12 by a time-to-frequency domain converter 22, such as a fast Fourier transform (FFT) processor, and inputting the resulting frequency domain data to the display processor 18 for combination with the measurement results 26 before presentation on the simultaneous display 20. As shown in FIG. 2 the spectrum view 24 is centered on a frequency channel at 1 GHz and has a span wide enough (5 MHz) to include the adjacent frequency channels. In the particular measurement results 26 a frame of the TD-SCDMA signal for each channel is shown, starting with the pilot signal at the left and the first six time-slots. It is readily apparent which time-slots are active (power level high) and which are inactive (power level low). Therefore by observing the measurements for multiple channels on the simultaneous display 20, events that affect more than one channel may be observed within a single acquisition.

The first step in the process is the seamless time domain acquisition of the RF signal by the acquisition module 12. This data is stored in a memory 28 having a range of locations from 0 to N, as shown in the illustration of FIG. 3, which represent discrete time increments determined by the sampling rate used by the acquisition module 12. The second step is to select the sequence of samples from the memory 28 for processing. The next three steps include filtering each channel and making the channel measurements while converting the selected time elements to the frequency domain. The sixth step is the combining step for composing the results from steps four and five into a single raster display. The final step is to produce the raster display on the simultaneous display 20 and then return either to step one (realtime processing) or step two (post-processing).

Thus the present invention provides an activity monitor for multiple RF channels in a communication signal by processing acquired data from the communication signal over a wide bandwidth with separate channel filters, measuring the data from each channel filter, and combining the measured data and a frequency domain version of the acquired data on a simultaneous display.

What is claimed is:

1. An activity monitor for multiple channels in an RF signal comprising:
means for acquiring time domain data from the RF signal;
means for separating the acquired time domain data to produce channel data for each channel;
means for measuring the channel data to produce measurement results for each channel; and
means for combining selected ones of the measurement results to provide a simultaneous display of the selected measurement results.

2. The activity monitor as recited in claim 1 further comprising means for converting a selected portion of the acquired time domain data to produce frequency domain data for combination with the selected measurement results by the combining means.

3. A method of monitoring activity on multiple channels of an RF signal comprising the steps of:
acquiring time domain data from the RF signal;
separating the acquired time domain data to produce channel data for each channel;
measuring the channel data to produce measurement results for each channel; and
combining selected ones of the measurement results to provide a simultaneous display of the selected measurement results.

4. The method as recited in claim 3 further comprising the step of converting a selected portion of the acquired time domain data to produce frequency domain data for combination with the selected measurement results by the combining step.
